(19) United States
(12) Patent Application Publication
(10) Pub. No.: US 2014/0260823 A1
(43) Pub. Date: Sep. 18, 2014

(54) UNIVERSAL WRENCH FOR ADJUSTMENT OF C-STAND HANDLES

(71) Applicant: John Huggins, Los Angeles, CA (US)

(72) Inventor: John Huggins, Los Angeles, CA (US)

(21) Appl. No.: 14/209,770

(22) Filed: Mar. 13, 2014

Related U.S. Application Data
(63) Continuation-in-part of application No. 29/469,659, filed on Oct. 11, 2013.
Application No. 29/469,659 is a continuation-in-part of application No. 29/469,660, filed on Oct. 11, 2013.
(60) Provisional application No. 61/784,953, filed on Mar. 14, 2013.

(51) Int. Cl. B25B 13/50

(52) U.S. Cl. CPC B25B 13/50
USPC 81/121.1

(57) ABSTRACT

A universal wrench may include a socket including an inner profile contoured to engage outer perimeters of differently-sized generally oval manual handles only when a long axis of the universal receptacle is not parallel to respective long axes of the generally oval manual handles and a handle extending from a base of the universal receptacle. The socket is of elongated form, in that it may be defined by substantially parallel walls spaced a distance apart and comprising the inner profile, said parallel walls being at least about twice as long as the distance. The inner profile may be principally defined by the substantially parallel walls of the socket.

### CROSS-REFERENCE TO RELATED APPLICATION

This application claims priority pursuant to 35 U.S.C. §119(e) to U.S. provisional application Ser. No. 61/784,953 filed Mar. 14, 2013, and is a continuation-in-part of U.S. design patent application Ser. Nos. 29/469,659 and 29/469,660, both filed Oct. 11, 2013. All of the aforementioned applications are hereby incorporated by reference, in their entireties.

### FIELD

The present disclosure relates to wrenches used to adjust handles configured for manual torqueing by a human hand, for example, c-stand handles.

### BACKGROUND

C-stands are frequently used in movie and television production to accomplish a variety of tasks. Typically, they are used to mount and position cameras, light sources, microphones, and props. However, c-stands may be used to mount virtually any piece of equipment that can be sufficiently supported on the stand.

Most c-stands include a tripod base and extendable and pivotable members. For many types of c-stands, the extendable and pivotable members are coupled to a stand using collars, threaded pins, and elongated oval-shaped knobs or handles, which are attached to the pins. Traditionally, the knobs and handles are meant for adjustment by hand, meaning that a user grips the handle with his or her hand and applies torque directly to the knob or handle, without using any tool to apply torque.

While hand adjustment is convenient, sometimes it is very difficult to torque c-stand handles by hand to a desired degree of tightness, or to loosen tightly-torqued handles. In these instances, it may become difficult to ensure that c-stand components stay in desired positions or to quickly make adjustments without stressing the operator's hand. C-stand handles are also typically not manufactured in standard sizes. Therefore, c-stand adjustment using traditional wrenches and standard tools is often inconvenient or not feasible.

Considering the difficulties encountered through hand manipulation of c-stand handles, there is a need for tools specific for c-stand handle and similar handle adjustment. The present invention fulfills this need and provides further related advantages, as described below. Reference will be made to the appended sheets of drawings which will first be described briefly.

### SUMMARY

A universal wrench for c-stand handles of various different sizes is described herein. Certain aspects of the wrench are described in this summary section, not to the derogation of other aspects described elsewhere herein. Although the description treats c-stand handles as an example, it should be appreciated that the wrench is not limited for use with c-stand handles, but may be used with any similar fastener handle of a generally oval shape designed for manual torqueing directly by the human hand.

The universal wrench may include a socket including an inner profile contoured to engage outer perimeters of differently-sized generally oval manual handles only when a long axis of the universal receptacle is not parallel to respective long axes of the generally oval manual handles and a handle extending from a base of the universal receptacle. The socket is of elongated form, in that it may be defined by substantially parallel walls spaced a distance apart and comprising the inner profile, said parallel walls being at least about twice as long as the distance. The inner profile may be principally defined by the substantially parallel walls of the socket.

The universal wrench may further comprise a bottom member of the cavity spanning the substantially parallel walls along respective edges thereof. The bottom member may comprise a continuous unbroken sheet, or may include openings and/or discrete support members. Functions of the bottom may include guiding the differently-sized generally oval manual handles to rest between the substantially parallel walls, which comprise the active surfaces applying torque to the handle when the wrench is turned, and supporting the substantially parallel walls along lower edges thereof. The universal wrench may further include a pair of optionally arcuate end walls coupling the substantially parallel walls at respective ends thereof, for further support if the longer parallel walls. The end walls generally need not engage the manual handles or be used apply torque, although incidental contact between the handles and the end walls, including incidental application of torque, may be tolerable. In an aspect, the socket and the handle may form a unibody construction.

In another aspect, the inner profile may be configured to not engage the generally oval manual handles when centered and parallel to respective long axes of the generally oval manual handles. In other words, the width of the socket may be substantially larger (e.g., in the range of about 3-20% larger) than the widest expected manual handle that the wrench is designed for. Accordingly; the socket can fit loosely over the handle head without close engagement. Once the wrench is turned, as the long axis of the wrench socket turns out of alignment with long axis of the generally oval manual handle, the long parallel sides of the socket engage side edges of the handle.

Accordingly, a method of turning a manual fastener for adjusting one or more members of a c-stand may include positioning a socket of a wrench over an outer perimeter of a c-stand handle for a fastener, wherein the socket is defined by substantially parallel walls spaced a distance apart, said parallel was being at least twice as long as the distance. The method may further include applying torque to the wrench, thereby engaging the parallel walls with the c-stand handle at two opposing engagement points around the outer perimeter. The method may further include turning the wrench, thereby turning the c-stand handle by torque applied through the two engagement points. In an aspect, turning the wrench loosens the fastener. Accordingly, the method may further include adjusting at least one c-stand member after loosening the fastener, and then reversing a direction of the turning to tighten the fastener.

Advantageously, the disclosed wrench and method of use may facilitate easier and more reliable adjustment of c-stands and the like, by providing the worker with a single versatile tool for torqueing normally hand-tightened fasteners of various sizes. Further aspects of the wrench and method of use may be apparent from the detailed description below, and accompanying drawings described briefly below.

### BRIEF DESCRIPTION OF THE DRAWINGS

The drawings described herein are for illustrative purposes and are not intended to limit the scope of the present disclosure. Like element numerals may be used to indicate like elements appearing in one or more of the figures.

FIG. 1 is a top perspective view of a universal wrench for c-stand and similar handles.

FIG. 2 is a top plan view of the universal wrench for c-stand handles of FIG. 1.

FIG. 3 is a bottom plan view of the universal wrench for c-stand handles of FIG. 1.

FIG. 4 is a handle end view of the wrench shown in FIGS. 1-3.

FIG. 5 is a head end view of the wrench shown in FIGS. 1-3.

FIG. 6A is a side view of the wrench shown in FIGS. 1-3

FIG. 6B is a top plan view of a wrench similar to the wrench of FIGS. 1-3, but without lightening holes.

FIG. 7 shows different types of two-lobed c-stand handles.

FIG. 8 is a perspective view of one type of c-shaped stand.

FIGS. 9A-B show alternative wrenches with a rectangular or partially rectangular receptacle, respectively.

FIG. 10 is a diagram illustrating features of the wrench socket design relating to engagement with ovoid fastener heads of various sizes.

FIG. 11 is a flow chart illustrating aspects of a method for using a wrench to turn a c-stand handle.

### DETAILED DESCRIPTION

Turning in detail to the drawings, FIGS. 1-6 show an embodiment of a universal wrench 10 for adjustment of one or more c-stand handles (FIGS. 7 and 8) and similar fasteners. The wrench may be made of any durable structural material, for example, aluminum, steel, or durable polymer material, for example by molding, casting, stamping, sintering, machining, or additive manufacturing (“3d printing”). The wrench 10 may include a “universal receptacle” 12 and a wrench handle 14 that extends from a base 16 of the universal receptacle 12. The universal receptacle 12 may also be referred to herein as a “socket.” The universal receptacle 12 may include at least one inner profile 18, which may be contoured to engage an outer perimeter 110 of a c-stand handle 100 under conditions as described herein. One or more inner profiles 18 are at least partially defined by surrounding a cavity 20 of the universal receptacle 12. The depth and width of the cavity 20 may be such that the receptacle 12 is configured to engage c-stand handles of various heights and widths, as described in more detail below. In an aspect, the at least one inner profile 18 may be contoured to engage an outer perimeter of a c-stand handle only when a long axis of the universal receptacle is not parallel to a long axis of the c-stand handle; in other words, the socket 12 may include an inner profile 18 contoured to engage outer perimeters of differently-sized generally oval manual handles only when a long axis of the universal receptacle is not at least substantially parallel to respective long axes of the generally oval manual handles. A more detailed example of such contouring is described in connection with FIGS. 1-6A and 9A-10 below.

The universal receptacle may also include a bottom wall 22 generally perpendicular to the walls of the inner profiles 18, such that the cavity 20 is a blind cavity. The bottom wall 22 may include any number or configuration of openings, consistent with its intended functions of supporting the side was 30, 31 (which provide the principal torqueing surfaces of the wrench 10 acting on c-stand handles) and helping to contain the c-stand handles between the parallel walls.

The wrench handle 14 may be elongated and of sufficient length and width for grasping by hand. Moreover, the length of the wrench handle should be sufficient to allow the wrench to tighten and loosen a c-stand handle of the types shown, for example, in FIGS. 7 and 8. In some configurations as shown in FIGS. 1-6B, the handle may also be provided with one or more openings 28 that lighten the overall weight of the wrench. FIG. 6B represent an alternative wrench 40 configuration, including a socket 42 identical to socket 12, and a handle 44 similar to the handle 14, except for omitting the lightening openings. The handles 14 or 44 may be of any suitable length or width; for example, about three to four inches long and about one inch wide. The handles should not be much longer than about four inches for the described wrench, to discourage over-torqueing, minimize material costs, and minimize wrench weight. Handles may optionally be provided with one or more gripping elements (e.g., rubber sleeves or co-molded rubberized plastics, not shown) that prevent slippage of the handle during use.

The universal wrench 10 may be manufactured according to various constructions. In one embodiment, the wrench has a unibody construction. In alternative embodiments, the handle and receptacle may be manufactured separately. For example, the base of the receptacle may be provided with a connection area (not shown) for coupling with various types of handles.

The outer body 25 of the universal receptacle, which includes the bottom wall 22 and sidewalls 23 and the inner cavity 20, may both be characterized by an elongated oval shape as shown in FIGS. 1-3. The inner profile 18 forms a functional wrench socket for engaging various shapes of c-stand handles without being restricted to a particular handle type. The elongated oval shape may be characterized by generally straight, parallel sidewalls 30, 31, which are joined at opposite ends by respective arcuate connecting walls 32, 33. In the depicted wrench 10, the arcuate connecting walls 32, 33 are characterized by having semi-circular cross sections. However, other arcuate or straight connecting walls may also be suitable, or one or both of the connecting walls may be omitted entirely. The cavity 20, by configuration of the sidewalls 30, 31 and connecting walls 32, 33, may have a smooth perimeter defining the inner profile 18 that is free of discontinuities, steps, lobes, protrusions, or other disruptions of the smooth parallel sidewalls 30, 31.

Although minor roughness of the profile 18 may be acceptable, in general the wrench 10 may function well for its intended purpose in the smooth configuration shown, which may enable it to easily fit over generally oval-shaped handles of various shapes. The profile 18 may define the cavity 20 of the socket 12 to have a length approximately two to three times longer than its width as shown in FIG. 2. For example, in one embodiment, ‘L’ may be about 3.6 inches and ‘w’ may be about 1.5 inches, resulting in a ratio of L/w of 2.4; the end walls 32, 33 may have a radius of about 0.75 inches; and all of the walls 30, 31, 32, 33 may have a uniform total height of about 0.75 inches. The wall height on the interior of the universal receptacle 12 may be uniformly reduced by a uniform thickness of about 0.62 inches, which may be the thickness of the bottom wall 22.

FIGS. 7 and 8 shows a plurality of c-stand handles 100. Each handle type 100a, 100b, 100c shown includes an outer perimeter 110a, 110b, 110c that is generally elongated and oval-shaped (ovoid). Top surfaces 112a, 112b, 112c of each handle may also be formed differently such that a user may press upon the handle for adjustment purposes. Each has also has a specific height 114 (for example, about 0.3 to 0.6 inches) and length 116 (for example, about 2.0 to 3.0 inches), and width 117 (for example, about 0.75 to 1.4 inches). The c-stand handle shapes shown in FIGS. 7 and 8 are merely representative. Traditional c-stand handles are known in the industry as t-handles and include an elongated and generally oval shaped outer perimeter oriented as a “t” to a threaded machine screw. Nonetheless, manufacturers of c-stands do not produce handles according to established standards; the handles may include other shapes and still work with the wrench 10, so long as the c-stand or similar handle fits within a generally ovoid envelope and has a length substantially greater than its width.

Within these loose parameters, the shape and size of c-stand handles may vary considerably, without frustrating the utility of the universal wrench 10. The wrench 10 may accommodate generally ovoid handles having a width 117 less than the cavity 20 width ‘w’ and length 116 less than the cavity 20 length ‘L’ while also greater than the cavity 20 width ‘w.’ The handle thickness 114 should also be less than the cavity depth. To accommodate sizes of c-stand handles outside the stated range, the cavity dimensions may be adjusted accordingly. However, the depicted wrench 10 is believed capable of torqueing nearly any c-stand handle in use today, without any need to changes wrenches or universal receptacle 12 sizes.

FIG. 8 shows one configuration of a c-stand 200 that includes a plurality of c-shaped handles 100. As shown, on a single c-stand, various handle sizes are used to position c-stand members 210, which are extendable and pivotable.

To use the wrench 10, a user positions the universal receptacle 12 over the outer perimeter of a c-stand handle 100. The overall height 114 of a c-stand handle 100, as shown in FIG. 7, should substantially fit within the cavity 20. The fit should be such that a c-stand handle fits adjacent to at least one inner profile 18 formed within the cavity 20, without close engagement with both parallel sidewalls 30, 31 until the wrench is turned. After positioning of the c-stand handle within the cavity 20, a user may apply torque to the outer perimeter 110 of the c-stand handles and tighten or loosen the c-stand handle for adjustment of c-stand members 210.

The universal wrench may be manufactured from one or more materials that do not deform after frequent use. Suitable material types may include metallic materials, such as aluminum, brass or stainless steel, structural polymers and composite materials. Preferably, the materials are corrosion resistant or provided with corrosion resistant coatings such that significant exposure to humidity and moistures does not prematurely degrade the wrench. The wrench is designed for torqueing fasteners designed for manual torqueing directly by human hands. As such, the material need not be overly strong, and rugged polymer materials (e.g., high-density polyethylene or polyamides) may suffice for lower cost.

FIG. 9A depicts an alternative wrench 300, wherein an inner profile 318 of the universal receptacle 312 is generally rectangular. Other features of the wrench 300, for example the handle 314, may be the same as, or similar to the features described above for the wrench 10. FIG. 9B shows another alternative wrench, wherein the inner profile 352 is midway between oval and rectangular. The opposing parallel walls 354, 356 may be spaced about 1.75 inches apart and may be about 3.80 inches long. The receptacle 358 may be about 1.06 inches deep. The end walls 360, 362 may be configured along arcs of a circle with a radius in the range of about 2.00 to 2.13 inches. Other features may be the same as or similar to previously described wrenches. The foregoing dimensions are for the purpose of example only.

FIG. 10 is a diagram illustrating aspects of the wrench design. A schematic wrench 400 is illustrated similar to wrench 300, in this case lacking end walls connecting the elongated parallel sidewalls 430, 431. The socket 412 has a central longitudinal axis aligned with the handle 414. Like wrenches 10 and 300, the schematic wrench 400 may include a socket 412 and handle 414. An elongated, ovoid handle head 402 is illustrated in an engaged position with the sidewalls 430, 431 of the socket 412. The handle head is coupled to a threaded fastener 404 at its center of rotation and has a longitudinal axis 490.

Prior to torqueing, when the wrench 400 is initially placed over the handle head 402, the longitudinal axis 490 of the handle 402 and the longitudinal axis 480 of the socket 412 may be more closely aligned than is depicted in FIG. 10. Such closer alignment will produce a gap between the handle head 402 and at least one of the parallel sidewalls 430, 431. When a side force indicated by the arrow 450 is applied to the handle 414, the wrench will rotate creating greater misalignment between the axes 480, 490 until the socket 412 engages the handle at two opposite points of the side walls 430, 431 located at the respective tips of the arrows 460, 470 indicating a torque couple. It should be apparent that the socket 412 can similarly torque any handle that is narrow enough to fit between the walls 430, 431, so long as the c-stand or similar handle is also longer than the distance between the parallel side walls 430, 431 (and for sockets having end walls, short enough to fit between the end walls).

Consistent with the foregoing, FIG. 11 illustrates a method 1100 for using a wrench such as described herein to torque a generally ovoid c-stand handle, or similar handle. The method 1100 may include, at 1110, positioning a socket of a wrench over an outer perimeter of a c-stand handle for a fastener, wherein the socket is defined by substantially parallel walls spaced a distance apart, said parallel walls being at least twice as long as the distance. The method may further include, at 1120, applying torque to the wrench, thereby engaging the parallel walls with the c-stand handle at two opposing engagement points around the outer perimeter. The method may further include, at 1130, turning the wrench, thereby turning the c-stand handle by torque applied through the two engagement points. In an aspect, turning the wrench loosens the fastener. Accordingly, the method may further include adjusting at least one c-stand member after loosening the fastener, and then reversing a direction of the turning to tighten the fastener.

Accordingly, a universal wrench for adjustment of c-stand handles, and method of use thereof, are disclosed. While certain embodiments have been shown and described, it will be apparent to those skilled in the art that many more modifications are possible without departing from the inventive concepts herein. The invention, therefore, is not to be restricted except in the spirit of the following claims.

What is claimed is:

1. A universal wrench for adjustment of c-stand handles, comprising:
a universal receptacle including at least one inner profile contoured to engage an outer perimeter of a c-stand handle only when a long axis of the universal receptacle is not parallel to a long axis of the c-stand handle; and
a wrench handle extending from a base of the universal receptacle.

2. The universal wrench of claim 1, wherein the at least one inner profile is at least partially defined within a cavity of the universal receptacle.

3. The universal wrench of claim 1, wherein the universal receptacle and the handle form a unibody construction.

4. The universal wrench of claim 1, wherein the at least one inner profile is configured to engage the c-stand handle having an elongated oval shape.

5. The universal wrench of claim 1, wherein the universal receptacle has an elongated oval outer perimeter.

6. The universal wrench of claim 1, wherein the universal receptacle is defined by substantially parallel walls spaced a distance apart and comprising the at least one inner profile, said parallel walls being at least twice as long as the distance.

7. The universal wrench of claim 6, further comprising a bottom of the cavity spanning the substantially parallel walls along respective edges thereof.

8. The universal wrench of claim 7, further comprising a pair of end walls coupling the substantially parallel walls at respective ends thereof.

9. The universal wrench of claim 7, wherein one of the pair of end was comprises the base of the handle.

10. A universal wrench for torqueing generally oval manual handles, comprising:
a socket including an inner profile contoured to engage outer perimeters of differently-sized generally oval manual handles only when a long axis of the universal receptacle is not parallel to respective long axes of the generally oval manual handles; and
a handle extending from a base of the universal receptacle.

11. The universal wrench of claim 10, wherein the inner profile is defined by walls of the socket.

12. The universal wrench of claim 10, wherein the socket and the handle form a unibody construction.

13. The universal wrench of claim 10, wherein the inner profile is configured to not engage the generally oval manual handles when centered and parallel to respective long axes of the generally oval manual handles.

14. The universal wrench of claim 10, wherein the socket has an elongated oval outer perimeter.

15. The universal wrench of claim 10, wherein the socket is defined by substantially parallel walls spaced a distance apart and comprising the inner profile, said parallel walls being at least twice as long as the distance.

16. The universal wrench of claim 15, further comprising a bottom of the cavity spanning the substantially parallel walls along respective edges thereof.

17. The universal wrench of claim 16, further comprising a pair of end walls coupling the substantially parallel walls at respective ends thereof.

18. A method of turning a c-stand handle for adjusting one or more members of a c-stand, comprising:
positioning a socket of a wrench over an outer perimeter of a c-stand handle for a fastener, wherein the socket is defined by substantially parallel walls spaced a distance apart, said parallel walls being at least twice as long as the distance;
applying torque to the wrench, thereby engaging the parallel walls with the c-stand handle at two opposing engagement points around the outer perimeter;
turning the wrench, thereby turning the c-stand handle by torque applied through the two engagement points.

19. The method of claim 11, wherein the turning loosens the fastener.

20. The method of claim 12, further comprising adjusting at least one c-stand member after loosening the fastener, and then reversing a direction of the turning to tighten the fastener.
